(19) United States
(12) Patent Application Publication
(10) Pub. No.: US 2026/0023559 A1
(43) Pub. Date: Jan. 22, 2026

(54) SYSTEM AND METHOD FOR MODELING SOFTWARE FROM EXTERNAL SYSTEMS

(71) Applicant: Leidos, Inc., Reston, VA (US)

(72) Inventors: Erin A. Smith Crabb, Haymarket, VA (US); Matthew T. Jones, Fairfax, VA (US); Laura D. Stagnaro, San Diego, CA (US)

(73) Assignee: Leidos, Inc., Reston, VA (US)

(21) Appl. No.: 18/983,462

(22) Filed: Dec. 17, 2024

Related U.S. Application Data
(60) Provisional application No. 63/671,951, filed on Jul. 16, 2024.
(60) Provisional application No. 63/692,200, filed on Sep. 9, 2024.

(51) Int. Cl. G06F 8/74; G06F 8/10; G06F 8/35

(52) U.S. Cl. CPC G06F 8/74; G06F 8/10; G06F 8/35

(57) ABSTRACT

A framework for generating a systems engineering model for a legacy system includes identifying and extracting code from a specific legacy system or repository and/or codebase; translating the learned code by feeding it to a LLM that specializes in code understanding to elicit natural language descriptions of the functionality of each segment of code and generate a text based output useable by a SysML generator to generate a SysML model of the legacy system from the LLM output.

### CROSS REFERENCE TO RELATED APPLICATIONS

The present application claims the benefit of priority to U.S. Provisional Patent Application No. 63/671,951 entitled SYSTEM AND METHOD FOR MODELING SOFTWARE FROM EXTERNAL SYSTEMS filed Jul. 16, 2024 and U.S. Provisional Patent Application No. 63/692,200 entitled SYSTEM AND METHOD FOR FACILITATING UNDERSTANDING OF SYSTEMS ENGINEERING WITH ARTIFICIAL INTELLIGENCE filed Sep. 9, 2024, both of which are incorporated herein by reference in their entirety.

### COMPUTER PROGRAM LISTINGS

An Appendix hereto includes the following computer program listings which are incorporated herein by reference: “LEID0058PRO_MoSES-Python-2024-04-04.jpynb.txt” created on Nov. 21, 2024 (7.48 KB) and “LEID0058PRO_MoSES-Java-2024-03-22.jpynb.txt” created on Nov. 21, 2024 (26.5 KB).

### BACKGROUND

### Field of Embodiments

Generally, the field of the embodiments is creation of systems engineering models for software.

### Description of Related Art

Every organization must continue to update and streamline their systems to enable modern applications and workflow to be more seamlessly integrated, or risk losing a competitive edge. However, many legacy systems present challenges to engineers due to complexity, unfamiliarity, or simply scale, resulting in a slow, costly modernization process. The current method for generating SysML models from document-based requirements, software code, and other available resources in Agile Digital Engineering heavily relies on skilled practitioners using a Graphical User Interface (GUI) to distill the necessary information from the original documents, identify the components that need to be represented, and finally to input those descriptions into a visually-rendered digital medium for reference and use. This process directly limits the number of practitioners by requiring a certain amount of background knowledge (both in the modeling process itself and the business domain), which in turn results in delays and increased time to product development when those personnel are unavailable.

Take for example, the scenario wherein a customer has a very large, complex repository of software source code, and needs to develop a comprehensive SysML model representation of code which would allow the identification of keyword-relevant and functionally duplicative artifacts. Under existing processes, the volume and complexity of information to be distilled, coupled with the limited availability of trained personnel and the fact that the process is human-reliant, necessarily means delayed processing and delivery.

There is a need in the art for improved systems and processes for digital modernization of legacy code systems.

### SUMMARY OF THE EMBODIMENTS

In a first exemplary embodiment, a system for generating one or more text-based model assembly documents for an external system's code repository for input to a systems modeling language (SysML) architectural model generator includes: an identification component for receiving code data from the code repository, identifying individual components and component functionality for the external system, and extracting individual component code for the identified individual components; a translation model for receiving the identified components and functionality with associated extracted individual component code and translating into natural language descriptions of the component functionality; and an assembly component for receiving the natural language descriptions of the component functionality with associated extracted individual component code and outputting one or more text-based model assembly documents descriptive of the external system.

In a second exemplary embodiment, a process for generating one or more text-based model assembly documents for an external system's code repository for input to a systems modeling language (SysML) architectural model generator includes: receiving code data from the code repository at an identification component, identifying individual components and component functionality for the external system, and extracting individual component code for the identified individual components; receiving the identified components and functionality with associated extracted individual component code at a translation model and translating into natural language descriptions of the component functionality; and receiving the natural language descriptions of the component functionality with associated extracted individual component code at an assembly component and outputting one or more model assembly documents descriptive of the external system.

### BRIEF SUMMARY OF THE FIGURES

Example embodiments will become more fully understood from the detailed description given herein below and the accompanying drawings, wherein like elements are represented by like reference characters, which are given by way of illustration only and thus do not limit the exemplary embodiments herein.

FIG. 1 shows high-level schematic of an exemplary Modeling Software from External Systems (MoSES) workflow in accordance with embodiments herein.

FIG. 2 is a snapshot of a Large Language Model (“LLM”) output file in accordance with embodiments herein.

FIG. 3 is a snapshot of a user interface for creating an import map from the output file using modeler software in accordance with embodiments herein.

FIG. 4 is a snapshot of a user interface rendering a system diagram from the mapped output file using modeler software in accordance with embodiments herein.

FIG. 5 is a snapshot of a user interface presented documentation created from the mapped output file using modeler software in accordance with embodiments herein.

FIG. 6 is a code snapshot of a prompt dictionary structure in accordance with embodiments herein.

### DETAILED DESCRIPTION

The embodiments described herein are directed to a process for Modeling Software from External Systems (MoSES) which empowers engineers to increase their ability and efficiency to modernize legacy code. MoSES is an easy-to-use, adaptable, local application that can quickly assess, understand, and decipher legacy code systems to facilitate the ability of engineers to more effectively engage with legacy system to understand technical architectures by producing architectural diagrams that document the legacy system. MoSES provides a secure, localized, light-weight application that can be easily customized to a target legacy system. MoSES leverages a Large Language Model (LLM) and prompts engineering in a three-step UTG (Understand, Translate, Generate) framework to help facilitate efficient and effective legacy system comprehension. First, the framework seeks to understand, i.e., identify and extract code from a specific legacy system or repository and/or codebase. This critical step aids in demarcating component boundaries, clarifying system interactions, and comprehensively evaluating functionality. The MoSES methodology is programming language neutral, making it an unmatched instrument for analyzing and deconstructing dense legacy software. Next, the framework translates the learned code by feeding it to a LLM that specializes in code understanding. The LLM elicits natural language descriptions of the functionality of each segment of code. Finally, the framework generates a SysML model; yielding the code in a representation that is recognizable and discernible to engineers. This model can then be used to verify that the abilities of the new application match that of the legacy one, reducing the risk of function loss.

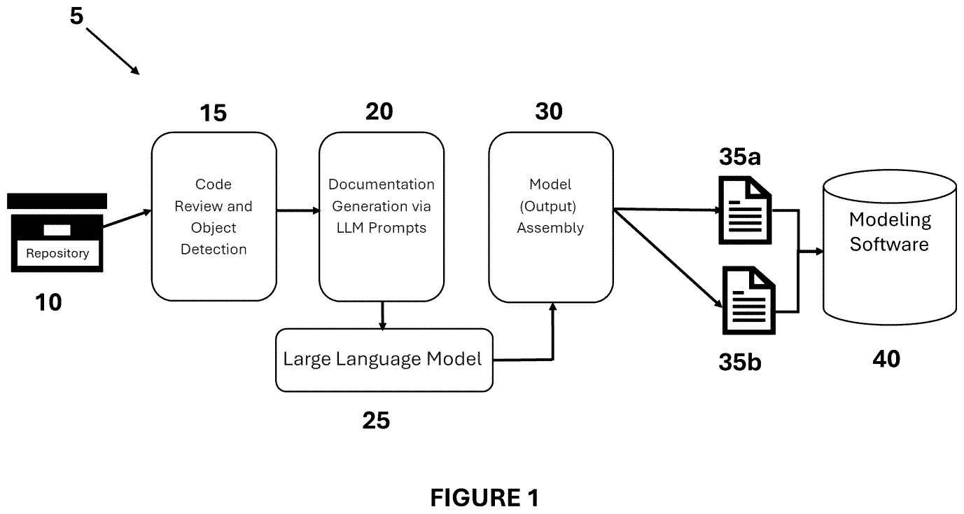

As shown in FIG. 1, MoSES is a workflow 5 that ingests a code repository 10 (e.g., legacy code), performs review and object detection 15, initiates documentation generation via LLM prompts 20 fed to an LLM (e.g., StarChat) 25, and outputs model assembly 30 including code snippets and associated textual descriptions 35a, 35b. As part of generating the LLM prompts 20, ingested repository code from 10 may be initially decomposed at 15 into a Universal Markup Language (UML)-like structure with descriptions of functionality for each component (and associated code). The code snippets and associated textual descriptions 35a, 35b may be exported to a modeler database 40 in a desired format, e.g., comma-separated values (CSV) (or other plain text file format that stores tabular data in a structured format), for further editing or importing by, for example, a software tool for model-based systems engineering (MBSE) that produces SysML model architectures which are understandable to a systems engineer and helps users design, manage, and analyze systems.

One such tool, the Cameo System Modeler, is a Model-Based Systems Engineering (MBSE) tool that strictly enforces most of OMG SysML's syntax and semantics, and offers support for basic requirements traceability, intermediate model-based simulation, and automated document generation. As is known to those skilled in the art, OMG SysML is a general-purpose modeling language for modeling systems that is intended to facilitate a model-based systems engineering (MBSE) approach to engineer systems. It provides the capability to create and visualize models that represent many different aspects of a system, e.g., requirements, structure, and behavior of the system, and the specification of analysis cases and verification cases used to analyze and verify the system. OMG SysML supports multiple systems engineering methods and practices, with individual methods and practices imposing additional constraints on how the language is used. Current OMG SysML language specification description is found in the OMG Systems Modeling Language (SysML) v2.0, Beta 1 document dated February 2024 which is incorporated herein by reference in its entirety.

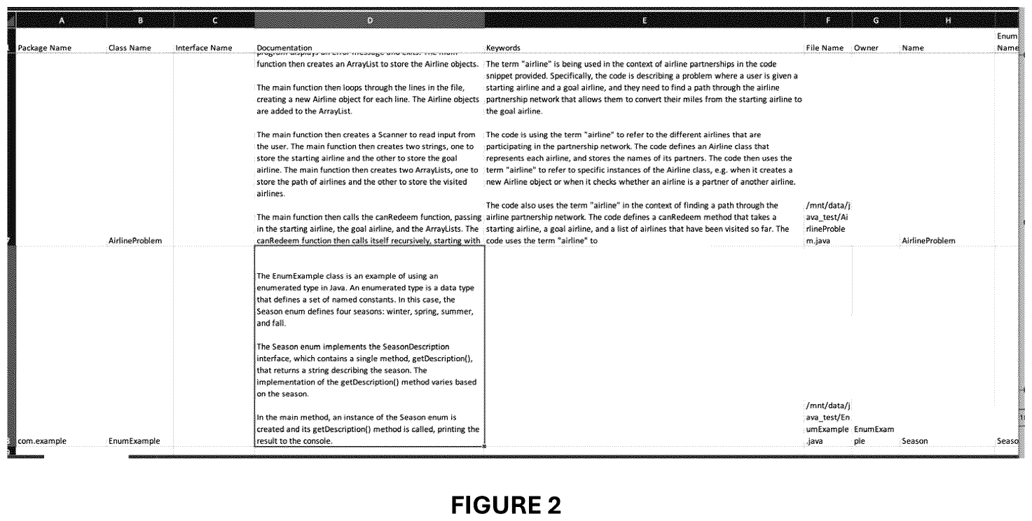

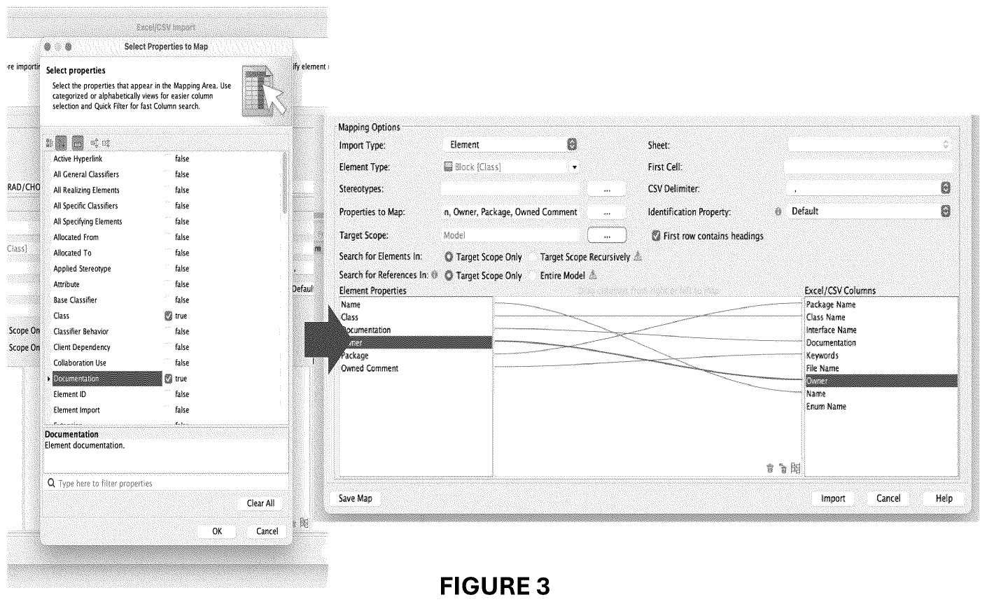

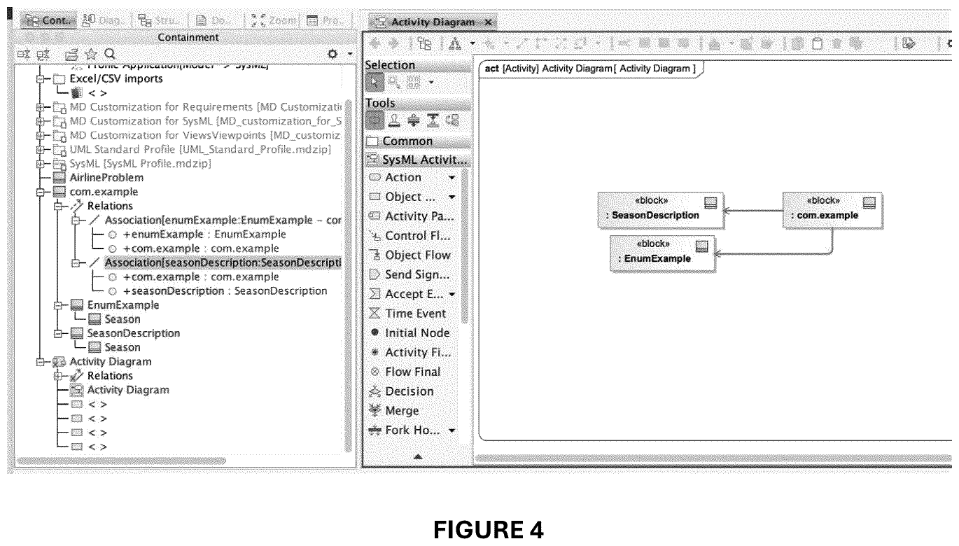

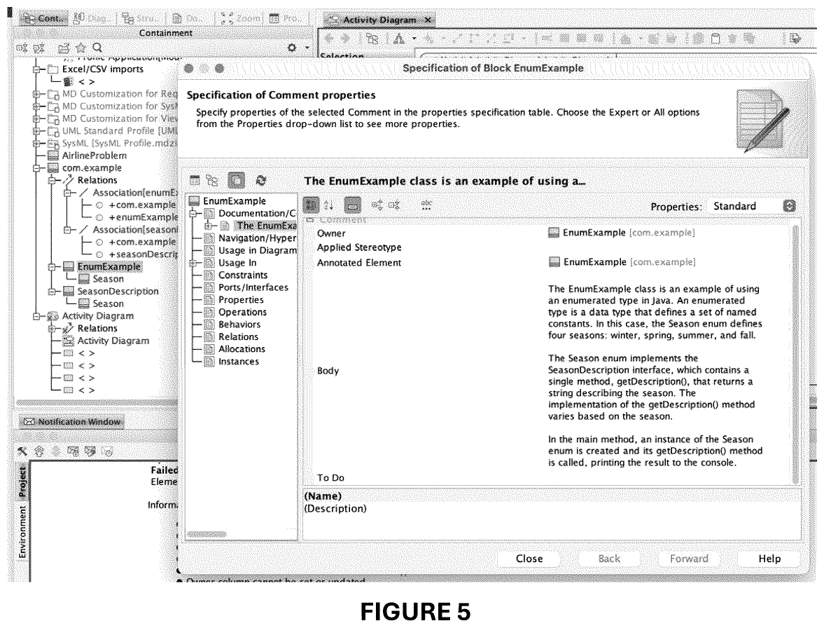

In a preferred embodiment, the LLM outputs are imported to Cameo System Modeler software. FIG. 2 provides a partial snapshot of an LLM CSV output file for use with Cameo System Modeler's import mapping function. To create an import map, users select the type of elements they wish to import (such as Block [Class]), and select the relevant properties supplied in the output as exemplified in FIG. 3. Users then drag the column names from the CSV to the appropriate Cameo field to import the values in order to connect the CSV fields to Cameo properties. The imported objects and relationships can then be rendered into a viewable diagram (FIG. 4), and the created documentation can be viewed and searched (FIG. 5).

MoSES is code agnostic and can be adapted to fit the needs of different customers. MoSES is capable of receiving text and source code from multiple sources and analyzing and synthesizing information from a great number of artifacts, documents and files at once, speeding up the time to development. MoSES eases the development process by offering human-readable descriptions of each functional unit being documented, and reduces the need for additional domain expertise by integrating an LLM which facilitates understanding of source code. A user can simply point MoSES at a legacy repository without any need to understand the programming language used, and MoSES returns a representation(s), e.g., localized, secure model(s) for digital transformation assistance, i.e., models that represent the necessary parts, actions, and integrations of a product or system, which is visually easy to comprehend.

MoSES is able to create a detailed systems engineering model of an unfamiliar computational code base, containing representative objects, relationships, and documentation. In a preferred embodiment, documentation may be created by prompts derived from the MagicGRID method (and framework) of model development described in Morkevicius et al., Towards a Common Systems Engineering Methodology to Cover a Complete System Development Process, July 2020, INCOSE International Symposium 30 (1): 138-152, which is incorporated herein by reference in its entirety. As is known to those skilled in the art, this framework is fully compatible with basic SysML (no extensions for SysML are required). It clearly defines the modeling process which was developed using the best practices of the systems engineering process. And it is tool-independent, as long as that tool supports SysML.

The resulting model is comprised of objects representing each code object: packages, classes, interfaces, enumerations, and so on. To develop each model component, we use a series of prompts to obtain summary documentation, keyword analysis, and other information from the chosen LLM about each object, and incorporate that information into the exported file. TABLE 1 below provides exemplary list of objects targets for model incorporation and the related prompts.

TABLE 1

| Object | Related Prompts |
|---|---|
| Package | “Please summarize the following package based on the |
| | documentation and code available. Do not summarize the |
| | low-level functions: [Code goes here]” |
| Class | “Return documentation for the following class which |
| | explains what the class does; do not return any of the code |
| | for the class. Do not create documentation for the functions, |
| | just the class: [Code goes here]” |
| | “Summarize the information about the following term in the |
| | following code. Restate the word found and describe what |
| | is interacting with it in the code piece. If it is an |
| | instantiation, please explain how it is being started and |
| | where in the code process that takes place.” |
| Interface | “Give me the details about these interfaces being |
| | implemented in this Java code snippet. List the interface |
| | name, what type of data is being returned and simple |
| | description of what the interface does. [Code goes here]” |
| | “Summarize the information about the following term in the |
| | following code. Restate the word found and describe what |
| | is interacting with it in the code piece: [Code goes here]” |
| Enumeration | “Please return documentation for the following enum that |
| | explains its purpose and members. Do not return any of the |
| | code: [Code goes here]” |
| | “Summarize the information about the following term in the |
| | following code. Restate the word found and describe what |
| | is interacting with it in the code piece: [Code goes here]” |

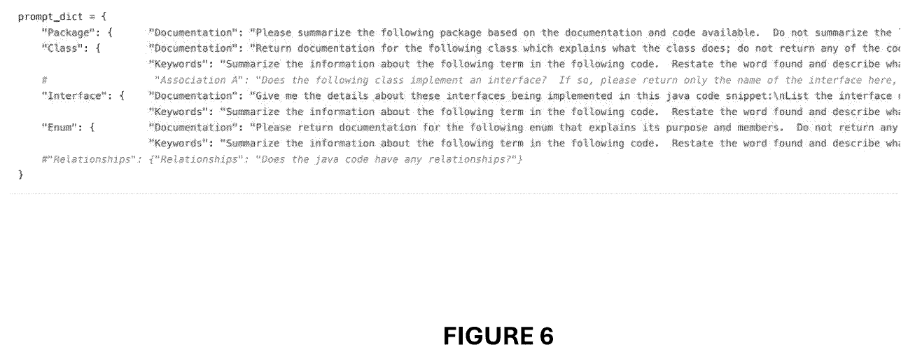

Further to an exemplary embodiment, current notebooks support Java and Python and support prompt engineering as they are designed to be modular and customizable, i.e., prompt dictionary and output columns. The MoSES prompt dictionary is structured as a dictionary of dictionaries. In the exemplary embodiment described herein, it is organized by artifact type and then mapped so the answer is connected to the desired Cameo output field as exemplified in FIG. 6. Prompts can be customized to answer any questions, but depending on the LLM chosen, users may get better or worse answers. For example, the StarChat LLM is designed to answer and respond to questions about software code, including readable descriptions of functionality, integrations, and connections. In the exemplary implementation, MoSES is designed to submit the appropriate code section with the associated prompt; this means the LLM has access to a limited amount of code to interpret at once. One skilled in the art will appreciate that additional support for cross-code searching and better integration explanations are extensions of this functionality. Exemplary Java and Python notebook code are shown in the Computer Program Listings submitted herewith as Appendices and are fully incorporated herein by reference.

The selected exemplary LLM is StarChat-B, an LLM trained on over 80 programming languages, with a focused instructional training set. StarChat language models are trained to act as coding assistants. StarChat can be replaced with any open or closed-source model by following that selected LLM's API, as would be appreciated by those skilled in the art.

MoSES is highly beneficial to systems engineers, solution architects and software developers as it is able to: provide basic modeling of unfamiliar code bases very quickly; facilitate understanding of computational code and its interactions for engineers with little to no programming experience; highlight keywords of interest and provide documentation on where they are being used and how; facilitates proposal development by accelerating modeling activities; contributes to developer understanding of legacy code and highlight legacy code functionality and interaction.

MoSES is computationally efficient and greatly accelerates model development. Current exemplary implementations can create basic/small models, e.g., <25 code objects with basic documentation, in approximately 3-5 minutes. For complex models, e.g., >750 files containing varying numbers of code objects, with detailed documentation, models can be created in 7-10 computational hours (without oversight).

MoSES may be placed in localized, on-premise computational environments through model caching, supporting modernization in high clearance and classified domains requiring implementation in a secure, closed environment.

The hardware specifications for the embodiments described herein include:
vCPUs: 48
Memory: 192.0 GiB.
Physical Processor: Intel Xeon Family
Clock Speed: 2.5 GHZ
CPU Architecture: x86_64
GPU: 4
GPU Architecture: NVIDIA T4 Tensor Core
Video Memory: 64.
   One skilled in the art will appreciate the alternative hardware configurations which may be used in view of specific processing requirements.

It is to be understood that the novel concepts described and illustrated herein may assume various alternative configurations, except where expressly specified to the contrary. It is also to be understood that the specific systems, devices and processes illustrated in the attached drawings, and described herein, are simply exemplary embodiments of the embodied concepts defined in the appended claims.

Reference in the specification to “one embodiment” or to “an embodiment” means that a particular element, feature, structure, or characteristic described in connection with the embodiments is included in at least one embodiment. The appearance of the phrases “in one embodiment,” “in some embodiments,” and “in other embodiments” in the specification are not necessarily all referring to the same embodiment or the same set of embodiments.

We claim:

1. A system for generating one or more text-based model assembly documents for an external system's code repository for input to a systems modeling language (SysML) architectural model generator, the system comprising:
an identification component for receiving code data from the code repository, identifying individual components and component functionality for the external system, and extracting individual component code for the identified individual components;
a translation model for receiving the identified components and functionality with associated extracted individual component code and translating into natural language descriptions of the component functionality; and
an assembly component for receiving the natural language descriptions of the component functionality with associated extracted individual component code and outputting one or more text-based model assembly documents descriptive of the external system.

2. The system of claim 1 further comprising: a SysML architectural model generator for receiving the text-based model assembly output and generating an architectural model representation of the external system.

3. The system of claim 1, wherein the translation model is a large language model.

4. The system of claim 3, wherein the large language model is trained to assist a user with coding.

5. The system of claim 1, wherein the one or more model assembly documents are in a plain text tabular format.

6. The system of claim 1, wherein the identification component is code-language agnostic.

7. The system of claim 1, wherein the code repository includes one or more artifacts, documents and files. objects, relationships, and documentation.

8. The system of claim 1, wherein the identification component and the assembly component are individual software programs.

9. The system of claim 1, wherein identifying individual components and component functionality for the external system from the code data includes an intermediate step of decomposed the code data into a Universal Markup Language (UML)-like structure.

10. The system of claim 1, wherein the architectural model is comprised of objects representing each code object selected from the group consisting of packages, classes, interfaces, and enumerations.

11. A process for generating one or more text-based model assembly documents for an external system's code repository for input to a systems modeling language (SysML) architectural model generator, the process comprising:
receiving code data from the code repository at an identification component, identifying individual components and component functionality for the external system, and extracting individual component code for the identified individual components;
receiving the identified components and functionality with associated extracted individual component code at a translation model and translating into natural language descriptions of the component functionality; and
receiving the natural language descriptions of the component functionality with associated extracted individual component code at an assembly component and outputting one or more model assembly documents descriptive of the external system.

12. The process of claim 11, further comprising:
receiving the text-based model assembly output at a SysML architectural model generator and generating an architectural model representation of the external system.

13. The process of claim 11, wherein the translation into natural language descriptions of the component functionality includes running the identified components and functionality with associated extracted individual component code through a large language model.

14. The process of claim 13, wherein the large language model is trained to assist a user with coding.

15. The process of claim 11, wherein the one or more model assembly documents are in a plain text tabular format.

16. The process of claim 11, wherein the identification component is code-language agnostic.

17. The process of claim 11, wherein the code repository includes one or more artifacts, documents and files.

18. The process of claim 11, wherein the identification component and the assembly component are individual software programs.

19. The process of claim 11, wherein identifying individual components and component functionality for the external system from the code data includes an intermediate step of decomposed the code data into a Universal Markup Language (UML)-like structure.

20. The process of claim 11, wherein the architectural model is comprised of objects representing each code object selected from the group consisting of packages, classes, interfaces, and enumerations.
